(19) United States
(12) Patent Application Publication
(10) Pub. No.: US 2009/0084314 A1
(43) Pub. Date: Apr. 2, 2009

(54) SPRING MEMBER, LIQUID CARTRIDGE INCLUDING THE SPRING MEMBER, AND RECORDING APPARATUS INCLUDING THE LIQUID CARTRIDGE

(75) Inventor: Kenji Matsuyama, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO ESPON CORORATION, Shinjuku-ku (JP)

(21) Appl. No.: 12/212,189

(22) Filed: Sep. 17, 2008

(30) Foreign Application Priority Data
Sep. 19, 2007 (JP) 2007-241902

(51) Int. Cl. B05C 5/02

(52) U.S. Cl. 118/300

(57) ABSTRACT

A spring member made by a simplified working process in which mistakes in assembling work are prevented, a liquid cartridge using the spring member, and a recording apparatus with the liquid cartridge are provided. A particular member of a spring member 1 is configured as a cap body 3 having an opening toward an elastic member and a sealing surface 3a at an end. An edge portion the opening is integrated with the elastic member 2. The cap body 3 includes a protruding piece 39 that protrudes from the edge portion of the opening of the cap body 3 toward the elastic member 2.

The entire disclosure of Japanese Patent Application No. 2007-241902, filed Sep. 19, 2007 is expressly incorporated by reference herein.

### BACKGROUND

1. Technical Field

The present invention relates to a spring member, a liquid cartridge including the spring member, and a recording apparatus including the liquid cartridge. In particular, the present invention relates to a spring member disposed in a liquid supply port of a liquid cartridge. The cartridge, which contains liquid, is mounted on a recording apparatus and supplies the liquid to the recording apparatus. The spring member is easily assembled and stably supplies liquid.

2. Related Art

Hitherto, an ink jet recording apparatus, for example, includes an ink cartridge mounted on a holder mechanism of a carriage. The carriage reciprocates in the main scanning direction driven by a mechanism such as a belt. The ink cartridge supplies ink to the recording head that ejects ink with which recording is performed on a recording medium.

Specifically, an ink supply needle disposed on the carriage is inserted into an ink supply port of the ink cartridge so that the ink supply needle pushes up an ink supply valve in the ink supply port and ink is supplied to the recording head.

The ink supply valve includes a coil spring and a valve lid fitted onto an end of the coil spring. The coil spring is an elastic spring member disposed in an ink supply port along the extension of the port. One end of the coil spring engages the vicinity of a supply port of a pressure control mechanism described below. The coil spring has a valve lid on the other end. The valve lid is a cylindrical tube one end of which is a tapered cone fitted into the coil spring. Near the opening of the ink supply port, ring-shaped packing is disposed along the peripheral edge of the opening. The coil spring urges the valve lid toward the opening of the ink supply port so that the valve lid contacts the packing and closes the opening of the ink supply port, thereby preventing the ink from leaking out of the ink cartridge. When the ink supply needle disposed in the carriage is inserted and pushes the valve lid up against the coil spring in the ink supply valve, the valve lid is separated from the seal member and the opening of the liquid supply port is opened so that the ink channel in the ink cartridge communicates with the ink channel in the recording head formed in the ink supply needle.

In this state, the ink in a container of the ink cartridge is supplied to the recording head through a pressure control valve in the ink cartridge. The pressure control valve is moved by a pressure difference between the ink cartridge and the recording head.

### [Patent Document 1] Japanese Unexamined Patent Application Publication No. 2001-144818

The ink supply valve disposed in the ink supply port of the ink cartridge is an assembly of a coil spring and a valve lid, which are independent members. Therefore, when making the ink cartridge, a worker has to assemble the ink supply valve while paying meticulous attention to sides and an insertion position of the valve lid and then fit the finished ink supply valve into the ink ejection port. If a worker makes a mistake regarding the sides or the insertion position of the valve lid, tightness between the valve lid and the packing disposed near an opening of the ink supply port is decreased or lost, which may cause the ink in the container to leak from the ink supply port. When the ink supply needle disposed on the carriage is inserted into the ink supply port, the valve lid may be pushed up in an unevenly inclined manner such that the ink is not stably supplied to the ink head. Moreover, when the ink supply needle is removed afterwards, the ink may leak because the tightness between the valve lid urged by a coil spring in an inclined manner and the packing is low.

### SUMMARY

The present invention aims to provide a spring member that solves the above-described problem, a liquid cartridge including the spring member, and a recording apparatus including the liquid cartridge.

To overcome the problem, a spring member includes an elastic member with elasticity in a certain direction, a particular member disposed at one or both ends of the elastic member, wherein the elastic member and the particular member are integrated. Since the particular member and the elastic member are integrated in such a spring member, the spring member can be fitted into a liquid cartridge with only consideration of the elastic member. Therefore, work for joining the coil spring to the valve lid can be omitted to simplify a working process. Moreover, the particular member is not joined in an inverted position, which ensures the reliability of the product.

The particular member of the spring member configured as above may be a cap body having an opening toward the elastic member and a sealing surface on an end of the cap body, and an edge portion of the opening may be integrated with the elastic member. Such a spring member as an assembly can be made in a simplified working process, in addition to the advantage of the spring member having the first configuration.

The cap body configured as above may include a protruding piece protruding from the edge portion of the opening toward the elastic member. In this case, in addition to the advantages of the above-described second and third configurations, the cap body is prevented from inclining even when a load is applied to the cap body in the direction such that the elastic member is contracted and inclined.

The elastic member of the spring member configured as above may be a spiral body made of a wound narrow metal strip. In this case, the spring member as an assembly can be made with a more simplified working process.

The elastic member of the spring member configured as above may be a narrow metal strip that is bent a plurality of times in the longitudinal direction. In this case, the spring member as an assembly can be made with a more simplified working process.

The cap body may be made from a metal plate integral with the elastic member by processing the metal plate by a pressing process or a drawing process. In this case, the spring member as an assembly is made with a more simplified working process since the work to join the cap body to the elastic member is omitted.

A liquid cartridge includes the spring member configured as above in the liquid supply port of the liquid cartridge and the elastic member that urges the cap body toward the opening of the liquid supply port and closes the liquid supply port. Such a liquid cartridge can be assembled without joining the valve lid and the coil spring as before. Moreover, since the elastic member contracts and the cap body does not incline when the liquid supply needle is inserted, the liquid supply port can be appropriately closed when the liquid supply needle is removed.

A high-quality recording apparatus can be provided by including the above-described liquid cartridge, since liquid is stably supplied to a liquid ejecting mechanism.

### BRIEF DESCRIPTION OF THE DRAWINGS

FIG. 1 is a perspective view showing an outline structure of spring members 1A, 1B, 1C, and 1D according to the present invention.

FIG. 2 is a view showing a process of making the spring member 1A according to the present invention.

FIG. 3 shows a front view, a perspective view and a sectional view of the spring member 1E according to the present invention.

FIG. 4 is a developed view of the spring member 1E according to the present invention.

FIG. 5 shows a perspective view and a partial enlarged view of a spring member 1F according to the present invention.

FIG. 6 is a perspective view showing an outline structure of a recording apparatus according to the present invention.

FIG. 7 is a sectional view showing an outline structure of a recording head.

FIG. 8 is an exploded perspective view of a liquid cartridge including the spring member 1A according to the present invention.

FIG. 9 is a sectional view showing a liquid cartridge including the spring member 1A according to the present invention and a liquid supply needle.

FIG. 10 is a sectional view showing a state when a liquid supply needle is inserted into a liquid cartridge including the spring member 1A according to the present invention.

FIG. 11 is a sectional view showing a state when a liquid supply needle is inserted into a liquid cartridge including the spring member 1E according to the present invention.

FIG. 12 is a sectional view showing a state when a liquid supply needle is inserted into a liquid cartridge including the spring member 1F according to the present invention.

### DESCRIPTION OF EXEMPLARY EMBODIMENTS

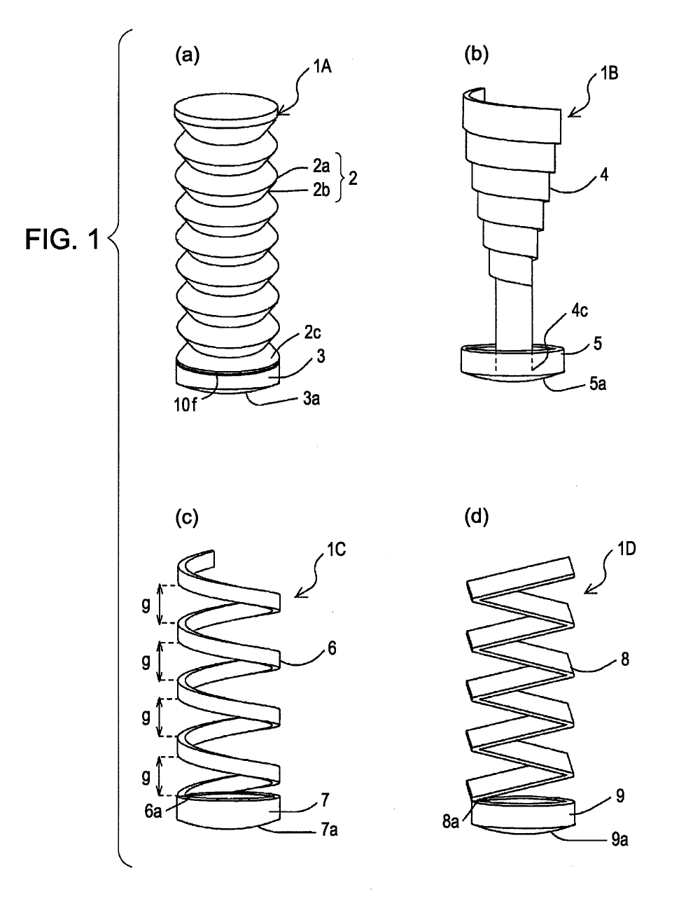

FIGS. 1(a) to 1(d) show outline structures of spring members according to the present invention. In an embodiment shown in FIG. 1(a), a spring member 1A includes an elastic member 2 and a cap body 3. The cap body 3, which serves as a particular member, is integrally formed with an end portion 2c of the elastic member 2. The elastic member 2 is a hollow bellows-shaped structure having major diameter portions 2a and minor diameter portions 2b. The elastic member 2 and the cap body 3 are made of a plate of metal such as aluminum, stainless steel, or copper.

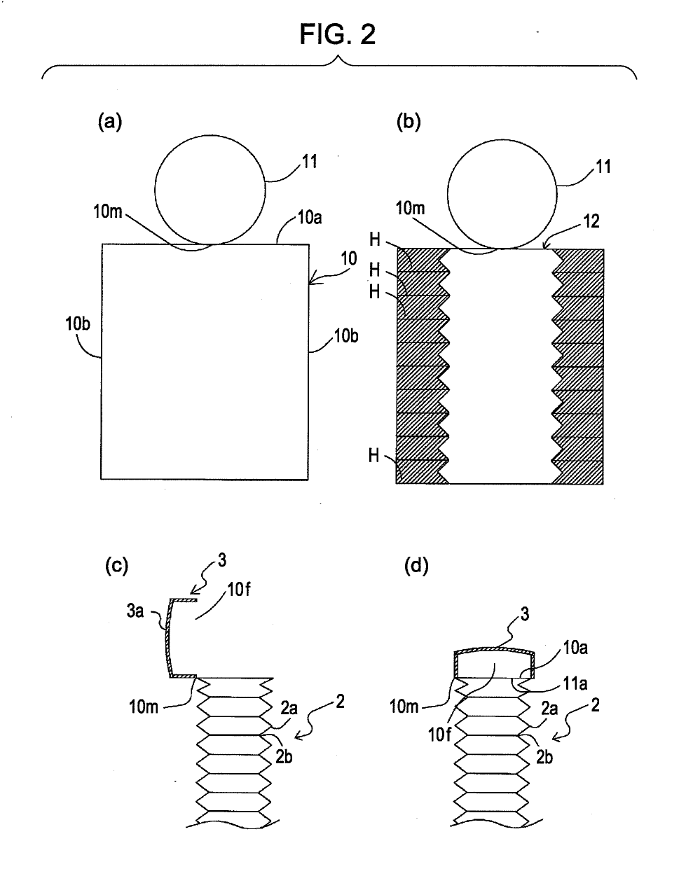

Referring to FIG. 2, a method for making the integrated component of the bellows-shaped elastic member 2 and the cap body 3 is described. As shown in FIG. 2(a), a rectangular metal plate 10 and a circular plate 11 are prepared. The circular plate 11 is joined to the center of an edge 10a of the rectangular plate 10 at a joint portion 10m. As shown in FIG. 2(b), the rectangular plate 10 is rolled into a tube and the side edges 10b are joined by welding or the like so as to make a cylinder 12 with open ends.

As shown in FIG. 2(b), dies H are stacked around the outer periphery of the cylinder 12 at an appropriate distance along the axis. The dies H for forming a bellows shape are known. The openings at both ends of the dies H are closed with lid members, and high-pressure fluid is injected into the cylinder 12 to apply a pressure from inside the cylinder 12. With the pressure, the surface of the cylinder 12 that does not contact the dies expands in a direction perpendicular to the axis and fits into the inner surfaces of the dies H. Thus, the elastic member 2 is given the bellows shape having the major diameter portions 2a and the minor diameter portions 2b. The elastic member 2 may be made by a drawing process. In this case, the cylinder 12 and dies (not shown) that contact the inner and the outer surfaces of the cylinder 12 are rotated together so as to form the major diameter portions 2a and the minor diameter portions 2b.

As shown in FIG. 2(c), the circular plate 11 is formed into the cap body 3 by a drawing process or a pressing process. The cap body 3 has an opening 10f on the side adjacent to the elastic member 2 and a sealing surface 3a at an end on the opposite side. As shown in FIG. 2(d), the cap body 3 is bent perpendicularly to the elastic member 2, which completes the process. A peripheral edge 11a of the circular plate 11 excluding the joint portion 10m and the edge 10a of the cap body 3 may be joined by welding or other means. By using the dies H, the spring member 1A including the elastic member 2 integrated with the cap body 3 is easily made. Alternatively, the cap body 3 on the cylinder 12 may be made first by a drawing process, and then the elastic member 2 with a bellows shape may be made by the above-described method.

FIG. 1(b) shows a spring member 1B according to another embodiment. The spring member 1B includes an elastic member 4 and a cap body 5. The elastic member 4 is formed by spirally winding a narrow strip of metal such as aluminum in a certain direction around, for example, a round bar. The cap body 5, which has a sealing surface 5a at an end, is joined to a bottom end 4c of the elastic member 4 so as to be integral with the elastic member 4. The elastic member 4 is imparted elasticity by spirally winding a metal strip in an overlapping manner. However, as shown in FIG. 1(c), the metal strip may be wound such that the adjacent parts are separated. Specifically, in FIG. 2(c), the spring member 1C has an elastic member 6 and a cap body 7. The elastic member 6, which is substantially spiral in shape, is formed by winding a narrow metal strip around a round bar or the like in a certain direction with a predetermined distance g. The cap body 7, which has an upward opening and a sealing surface 7a at an end, is joined to a bottom end 6a of the elastic member 6 and integrally formed with the elastic member 6.

As shown in FIG. 1(d), another spring member 1D includes an elastic member 8 and a cap body 9. The elastic member 8 is formed by bending a narrow strip of metal such as aluminum repeatedly in a dogleg manner in the longitudinal direction. The cap body 9, which has an upward opening and a sealing surface 9a at an end, is formed integrally with a part of a lower edge 8a of the elastic member 8.

With any of the spring members 1A to 1D having the above-described structures, the cap body serving as a particular member is joined to the elastic member at the end portion of the elastic member by a simple assembling process so as to constitute a single component. Thus, work to attach the cap body serving as the particular member to the elastic member is not necessary. Moreover, when an ink cartridge is assembled as described below, any of the spring members 1A to 1D can be fitted into the liquid supply port easily without paying attention to the attachment direction of the particular member. The elastic member and the cap body can be integrated easily by a process such as a pressing process or a drawing process.

The spring members 1A to 1D are described to illustrate exemplary general outline of the present invention, and the present invention is not limited to the above-described embodiments.

Hereinafter, further specifics of the spring member according to an embodiment of the present invention, an ink cartridge and a recording apparatus including the spring member are described in detail.

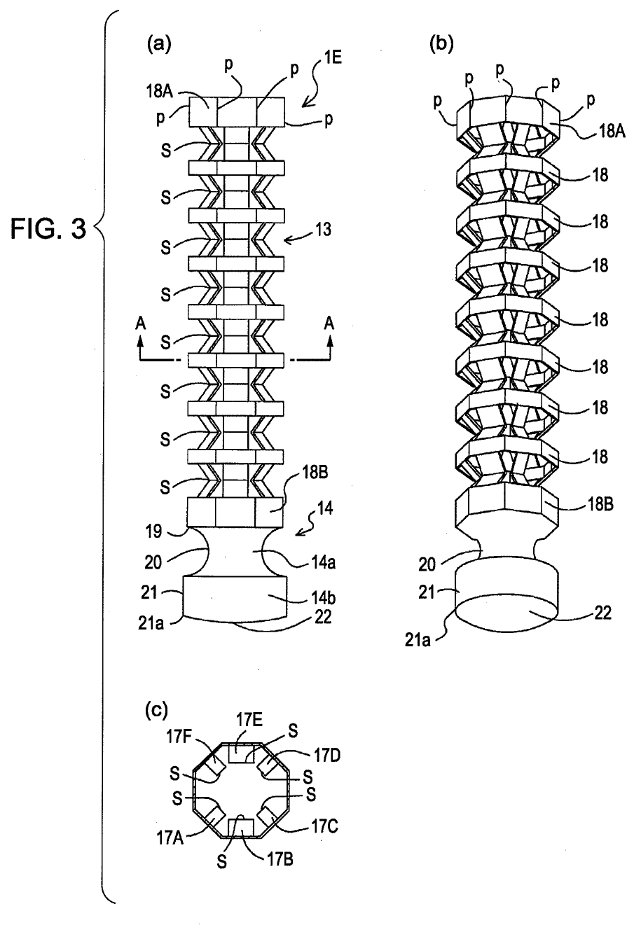

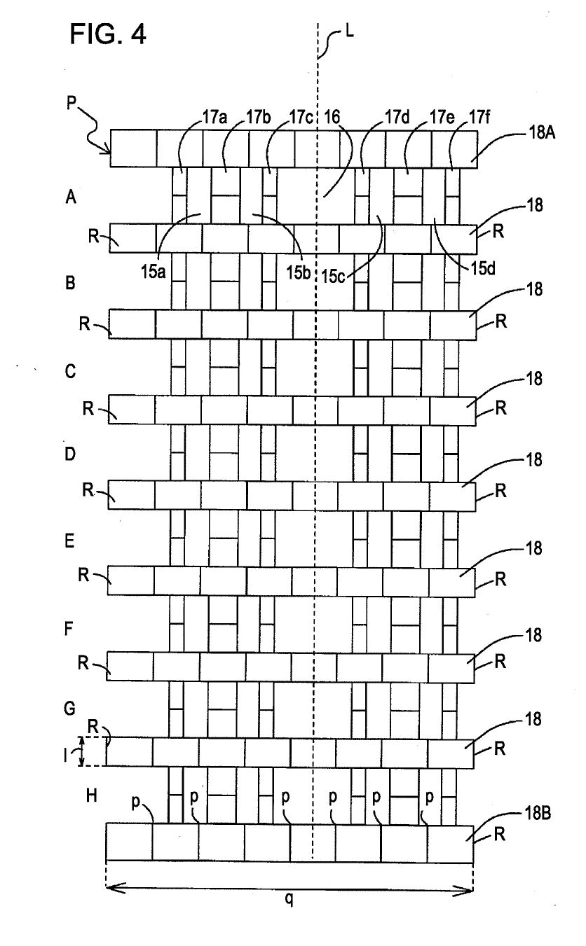

FIGS. 3(a), 3(b), 3(c), and 4 show an example of a spring member according to an embodiment of the present invention, which is a modification of the spring member A in FIG. 1(a). A spring member 1E in this modification includes an elastic member 13 and a cap body 14. The elastic member 13 is a hollow columnar body with an open end, which is formed by processing a plate of metal such as aluminum by a pressing process, a drawing process, or the like. The cap body 14 serving as a particular member is disposed on an end of the elastic member 13.

The elastic member 13 and the cap body 14 are formed into the columnar body having, for example, an octagonal section (see FIG. 3) as follows: as shown in FIG. 4, a rectangular metal plate P is punched to create small openings 15a to 15d and large openings 16 separated in the up-down and width directions with a certain distance. A mesh body, which includes elastic pieces 17(a) to 17(f) on the lateral sides of the openings and peripheral walls 18 on the upper and lower sides of the openings, is bent into, for example, the octagonal columnar body.

Referring to FIG. 4, a specific configuration is described by using the topmost tier A made by punching as an example.

The small opening 15a in the tier A is a rectangular opening having, for example, a height of 2 mm and a width of 1 mm. The adjacent small openings 15b, 15c, and 15d have the same area as that of the opening 15a. The large opening 16, which is wider than the small openings 15a to 15d, is provided at substantially the center of the metal plate P in the width direction.

Among the six elastic pieces 17(a) to 17(f) that are separated by the small openings 15a to 15d and the large opening 16, the elastic piece 17b is wider than the elastic pieces 17a and 17c adjacent to the elastic piece 17b, and the elastic pieces 17a and 17c have the same width. The elastic pieces 17d to 17f are disposed so as to be bilaterally symmetric with the elastic pieces 17a to 17c about an imaginary line L. Therefore, the widths of the elastic pieces 17b and 17e are the same, and the widths of the elastic pieces 17a, 17c, 17d, and 17f are the same.

As shown in FIG. 3(b), the peripheral walls 18 are surfaces that are located above and below the elastic pieces 17a to 17f in the tier A. The peripheral walls 18 connect the elastic pieces to the elastic pieces 17a to 17f in subjacent tier B and extend in the width direction.

The peripheral walls 18 have the same length l in the up-down direction except for the uppermost peripheral wall 18A and the lowermost peripheral wall 18B. The lengths of the peripheral wall 18A and the peripheral wall 18B in the up-down direction are greater than the lengths of other peripheral walls. The length q in the width direction is the same, for example, for all peripheral walls 18.

FIGS. 3(a) and 3(b) show a state in which the metal panel P having the above-described structure is bent at bending lines p on the peripheral walls 18 so as to form a tubular shape, and the left and right edges R of the peripheral walls 18 shown in FIG. 4 are joined by welding or the like. As shown FIG. 3(c), in this embodiment, the elastic member is formed as a columnar body having an octagonal section by providing seven bending portions p on the peripheral walls 18. However, the shape of the tubular body is not limited to this, and the shape may be a columnar body having a triangular section or another polygonal section.

As shown in the figure, the elastic pieces 17a to 17f disposed in tiers A to H are bent at bending lines S inward in the radial direction of the column in a dogleg manner.

Therefore, with the elastic member 13 of this configuration, when a load toward the peripheral wall 18A is applied to the cap body 14 described below with the peripheral wall 18A as the fixed side and the cap body 14 as the load side, the elastic pieces 17a to 17f disposed in the tiers A to H are further deformed at the bending lines S inward in the radial direction of the column, and the elastic member 13 as a whole contracts toward the peripheral wall 18A. When the load is removed, the dogleg-shaped elastic pieces 17a to 17f, which have been deformed, recover the angle and length they possessed before the load is applied, which provides the elastic member 13 with its normal length. In the above-described embodiment, the elastic member 13 has the eight tiers A to H. However, the number of tiers and the up-down length of the peripheral wall 18 may be modified as appropriate in accordance with the necessary length of the spring member.

The cap body 14, which extends downward from the peripheral edge 19, is formed integrally with the peripheral wall 18B in the lowest tier of the elastic member 13. The cap body 14 includes a neck portion 14a and a sealing portion 14b.

The neck portion 14a has a rounded surface 20 that extends downward from the peripheral edge 19 of the peripheral wall 18B and tapers inward in the radial direction of the column. Toward the bottom end, the neck portion 14a increasingly expands in diameter in the radial direction of the column. The sealing portion 14b, which is concentric with the column, has a side surface 21 extending downward from the bottom end of the rounded surface 20. The bottom of the sealing portion 14b is a sealing surface 22 that protrudes downward from the peripheral bottom edge 21a of the side surface 21 with a certain curvature.

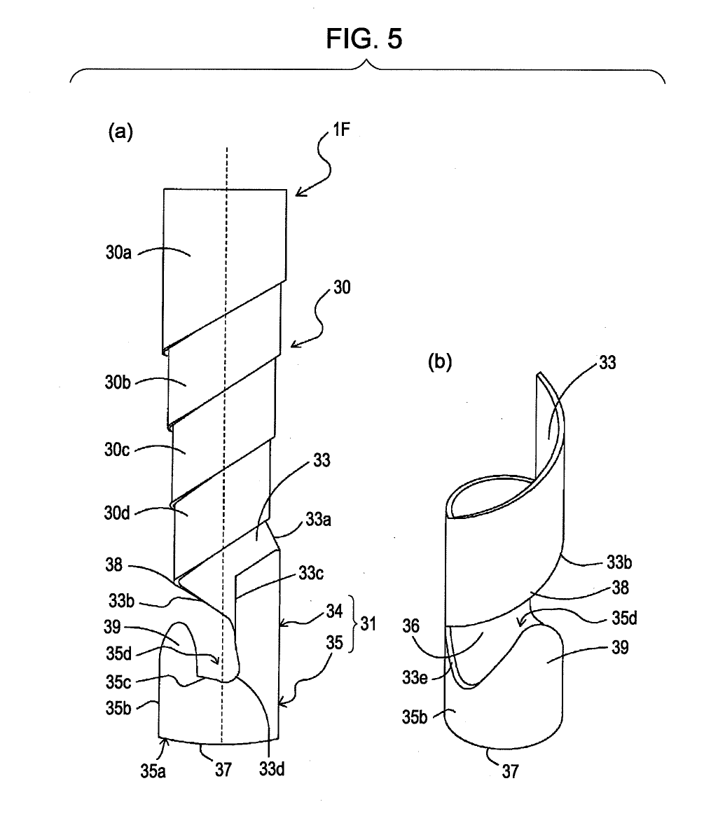

FIG. 5 shows a spring member according to another embodiment of the present invention. In particular, the figure shows a modification of the spring member 1B in FIG. 1(b). A spring member 1F in this embodiment includes an elastic member 30 and a cap body 31. The elastic member 30, which has a hollow structure, is formed by spirally winding a single strip of metal such as aluminum. The cap body 31 is disposed on an end of the elastic member 30.

The elastic member 30 is formed as a spiral structure including a plurality of tiers as described below by winding a rectangular strip a plurality of times. Among the tiers, the winding diameter of an upper tier 30a at the topmost position is larger than the winding diameter of a middle tier 30b subjacent to the upper tier 30a. The winding diameter of the middle tier 30b is larger than the winding diameter of another middle tier 30c subjacent to the middle tier 30b. The winding diameter of the middle tier 30c is larger than the winding diameter of a lower tier 30d subjacent to the middle tier 30c. When the winding diameter of the upper tier 30a is φ3.9, it is preferable, for example, that the winding diameter of the middle tier 30b be φ3.6, the winding diameter of the middle tier 30c be φ3.3, and the winding diameter of the lower tier 30d be 3.0.

With the elastic member 30 in the above-described configuration, when a load toward the upper tier 30a is applied to the cap body 31 with the upper tier 30a as the fixed side and the cap body 31 described below as the load side, a part of the outer peripheral surface of the lower tier 30d is within the winding diameter of the middle tier 30c, a part of the outer peripheral surface of the middle tier 30c is within the winding diameter of the middle tier 30b, a part of the outer peripheral surface of the middle tier 30b is within the winding diameter of the upper tier 30a immediately above, and the elastic member 30 as a whole contracts toward the upper tier 30a. When the load is removed, the parts of the outer peripheral surfaces of 30d, 30c, and 30b that have been within the winding diameters immediately above are exposed again, and the elastic member 30 recovers its normal length before the load is applied. The above-described embodiment has the four tiers 30a to 30d. However, the design may be modified as appropriate by changing the number of tiers and the winding diameter in accordance with the necessary length of spring member.

The cap body 31 is formed integrally with the above-described elastic member 30 by processing an end surface 33 of a metal strip extending downward from the lower tier 30d by a pressing process, a drawing process, or the like. The cap body 31 includes a narrow neck portion 34 and a cuplike sealing portion 35. The neck portion 34 is formed by winding the metal strip, which extends downward from the lower tier 30d, so as to be bent from the outside to the inside in the radial direction of the elastic member 30 such that the wound strip has a larger diameter than the winding diameter of the lower tier 30d immediately above.

Specifically, an upper side edge 33a of the end surface 33 extends from the outside in the radial direction to a position near the axis of the elastic member 30 shown by the dotted line. A lower side edge 33b of the end surface 33 extends from the outside in the radial direction to a position across the axis of the elastic member 30 shown by a dotted line. The upper side edge 33a includes a vertical edge 33c that extends downward along and near the axis and a curved edge 33d. The lower side edge 33b includes a curved edge 33e that extends outward in the radial direction from the position across the axis. That is, the neck portion 34 is a peripheral wall 36 provided by dividing the elastic member 30 substantially in half along the axis.

The sealing portion 35, which is cuplike, includes a bottom 35a, a peripheral wall 35b, and an opening 35d. The bottom 35a is substantially circular. The peripheral wall 35b extends upward from a peripheral edge of the bottom 35a. The opening 35d is formed by a ridgeline 35c of the peripheral wall 35b. The bottom 35a is formed as a sealing surface 37 that protrudes downward from the peripheral edge of the peripheral wall 35b with a certain curvature. The peripheral wall 35b is configured as a surface that is continuous with the curved edges 33d and 33e, and connects the arc-shaped ridgeline 35c and the peripheral edge of the bottom 35a.

The peripheral wall 35b also includes a protruding piece 39 at a position opposite the peripheral wall 36 of the neck portion 34. The protruding piece 39 is formed with the ridgeline 35c protruding in a bow shape at a position opposite the peripheral wall 36 toward the elastic member 30.

With this protruding piece 39, when a load to contract the elastic member 30 toward the upper tier 30a is applied not to the center but to a part of the bottom 35a below the protruding piece 39, the protruding piece 39 contacts the vicinity of an edge portion 38 of the lower tier 30d immediately above. This prevents the neck portion 34 from bending and the cap body 31 from inclining.

Hereinafter, embodiments of a liquid cartridge and a recording apparatus including the spring member with the above-described configuration are described in detail.

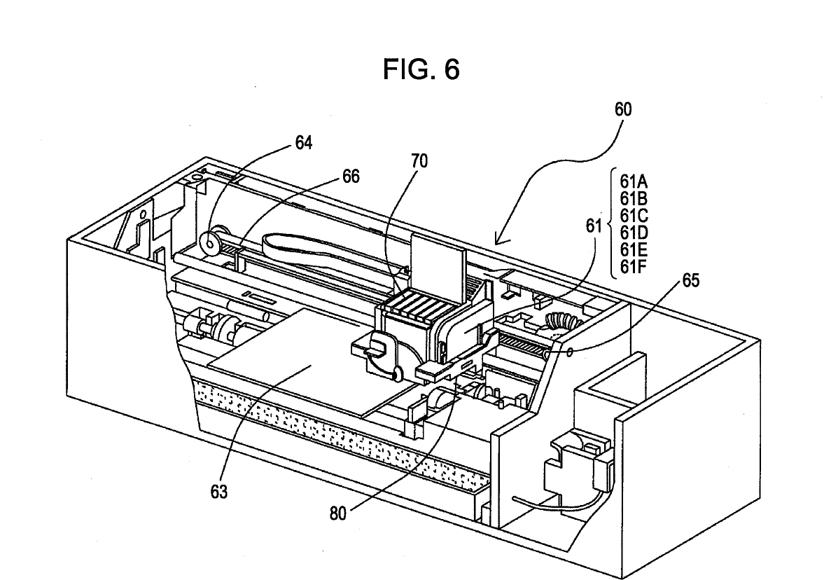

FIG. 6 shows an external structure of an ink jet printer 60 including a liquid cartridge. The ink jet printer is an example of a recording apparatus. A spring member and a liquid cartridge according to an embodiment of the present invention can be applied to printers using other printing methods. The term “liquid” includes ink with various properties such as pigment ink, dye ink, ink with high permeability, ink with low permeability, and a composite of these.

The ink jet printer 60 includes a carriage 61 on which a plurality of liquid cartridges 70 are mounted and a recording head 80 disposed below the carriage 61.

The carriage 61 is supported on a guide rod such that the carriage 61 reciprocates in a width direction of a recording medium 63. The carriage 61 is connected to a timing belt 66 that is spanned between a planetary pulley 64 and a driving pulley 65. The carriage 61 can move in the main scanning direction when a pulse motor (not shown) drives its axis connected to the driving pulley 65.

The carriage 61 includes, for example, six holder mechanisms 61A to 61F that can hold the plurality of liquid cartridges 70 therein. Each of the holder mechanisms 61A to 61F, which are separated with ribs, includes a liquid supply needle 100 described below that communicates with the recording head 80. The holder mechanisms 61A to 61F hold the liquid cartridges 70 containing color ink of black, cyan, magenta, yellow, etc. The liquid supply needle 100 of each of the liquid cartridges 70 is inserted into a liquid supply port 90.

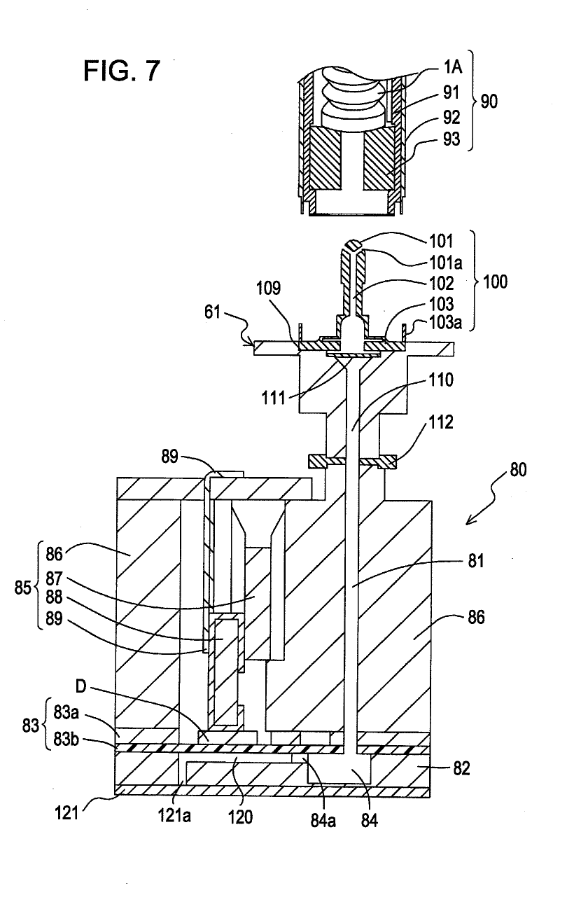

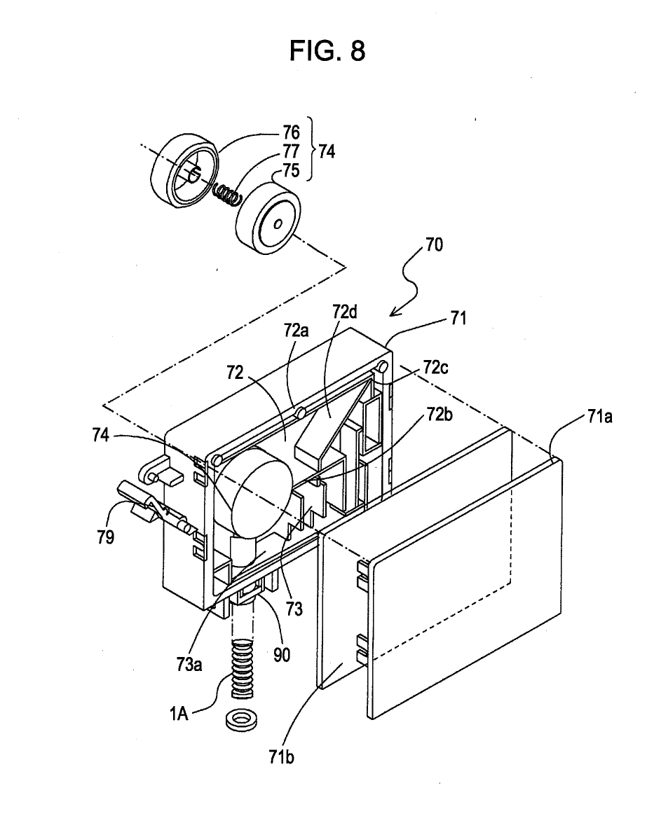

FIGS. 7 to 10 show outline structures of a liquid cartridge 70 having a spring member 1A according to the present invention that is fitted into the liquid supply port 90. In the figures, the liquid cartridge 70 includes a casing 71 and a lid 71a. The casing 71 is substantially box-shaped with an opening. The inside of the casing 71 includes upper and lower liquid containers 72 and 73 that contain liquid, a liquid channel (not shown) that connects the liquid containers 72 and 73 to the liquid supply port 90 described below, and a pressure control mechanism 74, which are integrally formed with propylene or the like.

The liquid containers 72 and 73 are formed by partition plates. The partition plates include, among others, inner wall plates 72a and 73a disposed in the upper and lower parts of the casing 71, a central wall plate 72b that divides the casing 71 in the up-down direction, and an inclined plate 72d that extends from an end of the central wall plate 72b to a corner 72c and divides the liquid containers 72 and 73 diagonally.

The pressure control mechanism 74 includes a valve seat 75 and a valve lid 76. The valve seat 75 is circular and held in a depression formed in the back face of the casing 71.

The valve seat 75 and the valve lid 76 are joined with a coil spring 77 serving as an urging member therebetween and held in the depression.

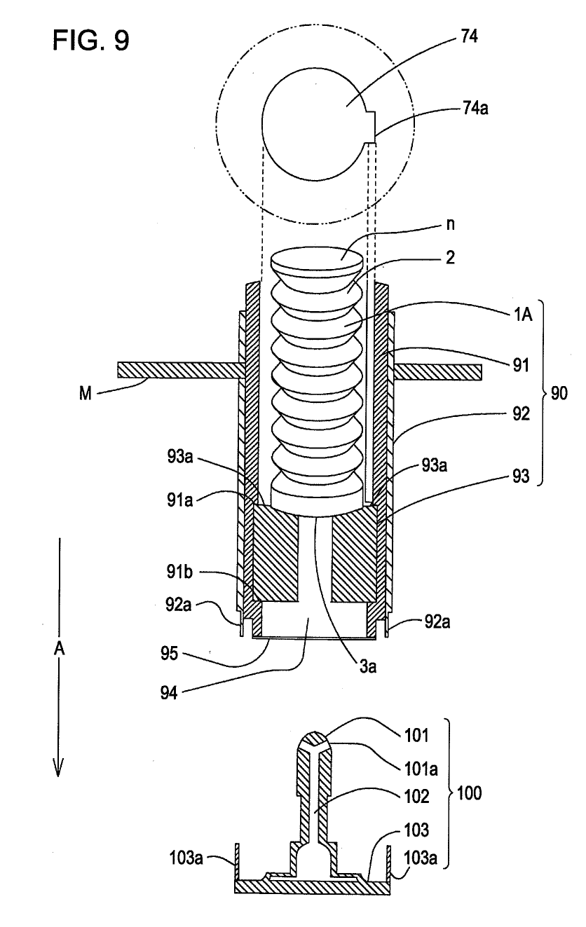

The valve seat 75 and the valve lid 76 of the pressure control mechanism 74 are configured to open and close with a negative pressure applied from the recording head 80 described below. With this movement, the liquid contained in the ink containers 72 and 73 is ejected from the liquid supply port 90 described below. A film 71b, which is disposed between the casing 71 and the lid 71a, is stuck over substantially the whole area of the opening of the casing 71 so as to seal the casing 71. The lid 71a is formed as a rectangular plate that closes the opening of the casing 71. The lid 71a is joined to the casing by an adhesive or the like in a state of not being sealed with the film 71b. The liquid cartridge 70 has an engagement lever 79 on its side. The engagement lever 79, which is an elastic plate protruding from the side of the liquid cartridge 70, engages with an engagement mechanism 103a (not shown) disposed in each of the holder mechanisms 61A to 61F in the carriage 61 (see FIG. 9).

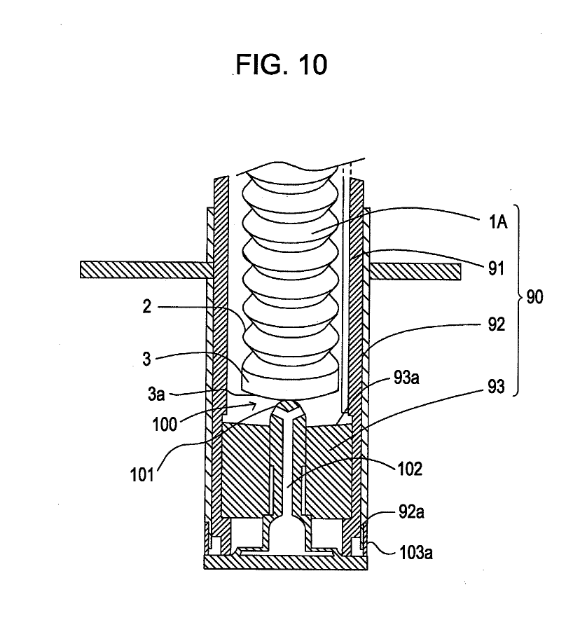

FIGS. 9 and 10 show enlarged sectional views of the liquid supply port 90 and the liquid supply needle 100 protruding from the carriage 61.

The liquid supply port 90 includes an insert receiving member 91 into which the liquid supply needle 100 of the carriage 61 is inserted, a guide rib 92 disposed around the insert receiving member 91, packing 93 disposed in the insert receiving member 91, and a spring member 1A as an example of a liquid supply valve.

The insert receiving member 91, which is substantially cylindrical, has a rear end that communicates with an ejection port 74a of the pressure control mechanism 74 in the liquid cartridge 70 and a front end that protrudes from a bottom surface M of the liquid cartridge 70 and extends to the point of the liquid supply needle 100. The insert receiving member 91 forms a channel through which ink that is discharged from the ejection port 74a of the pressure control mechanism 74 is supplied to the liquid supply needle 100.

The insert receiving member 91 has upper and lower engagement mechanisms 91a and 91b, which are steps formed inside. The packing 93, which is made of elastomer or the like, elastic, and torus-shaped, is inserted between the engagement mechanisms 91a and 91b. The guide rib 92 is integrally formed so as to protrude from the outer peripheral surface of the insert receiving member 91 outward in the radial direction. The guide rib 92 extends from the bottom surface M of the liquid cartridge 70 toward the point of the liquid supply needle 100. An engagement mechanism 92a is formed at the bottom end of the guide rib 92. The engagement mechanism 92a engages with the engagement mechanism 103a formed on each of the holder mechanisms 61A to 61F in the carriage 61. The engagement mechanism 92a guides the ink supply needle 100 so that the ink supply needle 100 is inserted straight into the liquid cartridge 70. Then, the engagement mechanism 92a is fixed to the holder mechanism 103a. An opening 94 is provided in the lower part of the insert receiving member 91. The opening 94 serves as an insert opening into which the liquid supply needle 100 is inserted as described below. The opening 94 is sealed with a film 95 when the liquid supply needle 100 is not inserted.

The spring member 1A, which serves as a liquid supply valve, is disposed in the insert receiving member 91. A rear end n of the elastic member 2 is fixed to an engagement piece (not shown) disposed in the insert receiving member 91. A sealing surface 3a of the cap body 3 faces the packing 93, and an upper surface 93a of the packing 93 contacts the sealing surface 3a of the cap body 3. The sealing surface 3a is provided with a curvature that is substantially the same as the curvature of the facing upper surface 93a of the packing 93 such that the sealing surface 3a is more closely fitted onto the upper surface 93a.

In summary, the spring member 1A that serves as a liquid supply valve in this embodiment includes the cap body 3 that serves as a valve body, and the cap body 3 has the sealing surface 3a facing the upper surface 93a of the packing 93. The elastic member 2 urges the cap body 3 downward in the insert receiving member 91 so that the sealing surface 3a contacts the upper surface 93 of the packing 93 and closes the upstream portion of the liquid channel provided by the insert receiving member 91.

The liquid supply needle 100 is a hollow needle made of, for example, epoxy resin. A tip portion 101 of the liquid supply needle 100 has a substantially conical shape. The tip portion 101 includes introduction ports 101a for introducing ink along the perimeter of the cone. The tip portion 101 contains a liquid channel 102 that communicates with the introduction ports 101a and extends to the opening of an intra-holder channel 110 described below.

The liquid supply needle 100 has a needle base 103 at the bottom. The needle base 103 is mounted on a needle holder 109 provided in the carriage 61 and fixed by a method such as welding or bonding.

The needle holder 109 includes the intra-holder channel 110 that expands like a funnel toward the needle base 103 of the liquid supply needle 100. As shown in FIG. 7, a filter 111, which filters ink to remove air and foreign substances in the ink, is disposed at the opening of the intra-holder channel 110.

Packing 112 is disposed in a downstream portion of the opening of the intra-holder channel 110. The intra-holder channel 110 communicates with an intra-head channel described below through the packing 112.

FIG. 7 shows an outline structure of a recording head. As shown in FIG. 7, the recording head 80, which is mounted below the carriage 61, includes an intra-head channel 81 and a liquid ejecting unit 85. The intra-head channel 81 communicates with the intra-holder channel 110 in the liquid supply needle 100. The liquid ejecting unit 85 ejects liquid, which is supplied through the intra-channel head 81, to a recording medium 63 with changes in pressure.

The liquid ejecting unit 85 includes a casing 86 made of, for example, epoxy resin. The casing 86, which is substantially rectangular, has an interior space divided into sections. The liquid ejecting unit 85 further includes a junction plate 87 contained in the casing 86, a piezoelectric vibrator 88 fixed to the junction plate 87, and a flexible cable 89 that supplies driving signals to the piezoelectric vibrator 88.

The piezoelectric vibrator 88 is, for example, a stack in which piezoelectric layers and electrode layers are stacked alternately so that the stack extends and contracts in the direction perpendicular to the stacking direction when a driving signal is supplied. The junction plate 87, which is fixed in the interior space of the casing 86, is a rectangular member with a thickness of, for example, about 1 mm. The junction plate 87 fixes the piezoelectric vibrator 88 and receives the reaction force of the piezoelectric vibrator 88.

The flexible cable 89 is, for example, a film-like plastic member. One end of the flexible cable 89 is fixed on the surface of the piezoelectric vibrator by soldering, and the other end is soldered to a substrate (not shown) mounted on the casing body.

The top end of the intra-head channel 81 communicates in a liquid-tight manner with the bottom end of the liquid supply needle 100 through the packing 112. The bottom end of the intra-head channel 81 includes a liquid reservoir 84 formed by a channel forming plate 82 and a layered body 83 described below. The intra-head channel 81 provides a channel through which the liquid, which is supplied from the liquid supply port 90 of the liquid cartridge 70 to the head, flows to a pressure-generating chamber 120 and a nozzle opening 121a described below to be discharged.

The intra-head channel 81 is a space formed between the channel forming plate 82 and the layered body 83. The intra-head channel 81 includes the liquid reservoir 84 for reserving ink in the channel, a supply port 84a that directly communicates with the liquid reservoir 84 and the pressure-generating chamber 120, and the nozzle opening 121.

The channel forming plate 82 is mounted on the bottom of the casing 86 with a layered body 83 therebetween. The channel forming plate 82 has a recess for forming the liquid reservoir 84 between the channel forming plate 82 and the layered body 83. The channel forming plate 82 provides a floor for the channel through the liquid reservoir 84, the supply port 84a, the pressure generating chamber 120, and the nozzle opening 121a. A nozzle surface 121 having the nozzle openings 121a is joined to the surface of the channel forming plate 82 opposite the side that is joined to the layered body.

The layered body 83 includes a support plate 83a made of, for example, stainless steel, and an elastic film 83b disposed on the bottom surface of the support plate 83a. The upper surface of the support plate 83a excluding an island portion D is joined to the bottom surface of the casing 86. The island portion D is made by removing a part of the support plate 83a by etching or the like. The upper surface of the island portion is joined to the free end of the piezoelectric vibrator 88. The elastic film 83b is formed by laminating polyphenylene sulfide (PPS), polyimide (PI), or the like, on the bottom surface of the support plate 83a.

With the recording head 80 having the above-described configuration, driving signals and the like are supplied from a controller (not shown) to the piezoelectric vibrator 88 through the flexible cable 89. The driving signals cause the piezoelectric vibrator 88 to extend and contract in the up-down direction. Then, the island portion D that is joined to the free end of the piezoelectric vibrator 88 extends and contracts, thereby causing the elastic film 83b to extend and contract. Therefore, the volume of the pressure-generating chamber 120 is increased and decreased, which causes the internal pressure to change and liquid in the pressure generating chamber 120 to be ejected from the nozzle opening 121a.

Specifically, when the piezoelectric vibrator 88 is charged so as to contract its free end in the longitudinal direction, the island portion D is pulled up so that the volume of the pressure generating chamber 120 is increased as compared with the state when the piezoelectric vibrator 88 is discharged. In contrast, when the piezoelectric vibrator 88 is discharged to extend its free end in the longitudinal direction, the island portion D is pressed to the pressure-generating chamber 120 so that the volume of the pressure-generating chamber 120 is decreased as compared with the state when the piezoelectric vibrator 88 is charged. In this embodiment, the piezoelectric vibrator 88 in what is called the flexural vibration mode was used. However, the vibrator is not limited to this and a vibrator in what is called the stretching vibration mode may be used.

Referring now to FIGS. 9 and 10, the relationship between the liquid supply port 90 and the liquid supply needle 100 when the liquid cartridge 70 is mounted on the holder mechanism 61A of the carriage 61 is described.

When the liquid cartridge 70 is pushed down to the liquid supply needle 100 along arrow A from the state shown in FIG. 9, the tip portion 101 penetrates the film 95 stuck over the opening 94 so as to be inserted into the insert receiving member 91 of the liquid cartridge 70.

As shown in FIG. 10, when the liquid cartridge 70 is pushed down further, the engagement mechanism 103a in the holder mechanism 61A engages the engagement mechanism 92a in the guide rib 92 such that the liquid cartridge 70 is mounted to the holder mechanism 61A substantially straight.

FIG. 10 shows that the liquid supply needle 100 is inserted into the liquid supply port 90 when the liquid cartridge 70 is mounted to the engagement mechanism 103a of the holder mechanism 61A as described above.

Specifically, the tip portion 101 of the liquid supply needle 100 contacts the sealing surface 3a of the spring member 1A serving as a liquid supply valve inserted through the opening 94 into the insert receiving member 91.

When the liquid cartridge 70 is pushed along the arrow, the tip portion 101 pushes up the cap body 3 serving as a valve lid to the upstream of the insert receiving member 91 serving as a channel against the elastic member 2. When the cap body 3 is pushed up, the upper surface 93a of the packing 93 and the sealing surface 3a are separated so that the liquid discharged out of the ejection port 74a of the pressure control mechanism 74 flows into the downstream portion of the insert receiving member 91 that serves as a channel.

At the same time, the downstream portion of the channel communicates with the liquid channel 102 in the liquid supply needle 100 in a liquid-tight manner via the introduction port 101a. The liquid is supplied to the ink head through the liquid channel 102 without leaking from the liquid supply port 90.

In the spring member 1A, the cap body 3 that serves as a valve lid of the liquid supply valve and the elastic member 2 that urges the cap body 3 are integrally formed. By applying such a spring member 1A to a liquid supply valve in the liquid supply port 90 of the liquid cartridge 70, a worker is not required to assemble the cap body 3 and the elastic member 2 together. As compared with the case when a liquid supply valve having a valve body and an elastic body as different members are assembled together and then fitted into the liquid cartridge 70, insufficient sealing due to an operational error can be prevented. This provides a high-quality liquid cartridge 70.

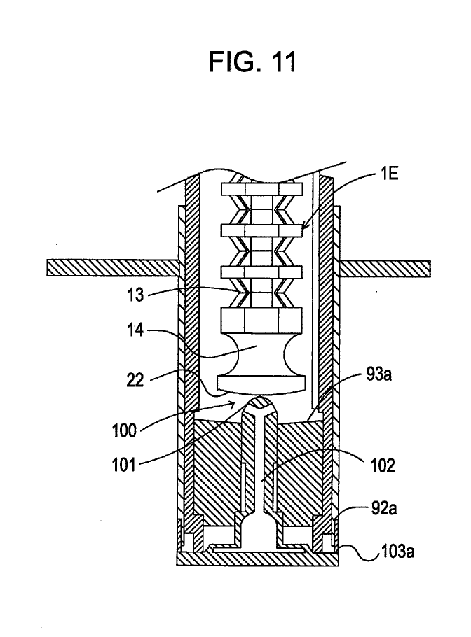

FIG. 11 shows a state when the above-described spring member 1E for a liquid supply valve is fitted into the liquid cartridge 70, and the liquid cartridge 70 is mounted on the engagement mechanism 103a in the holder mechanism 61A.

In this state, the tip portion 101 of the liquid supply needle 100 contacts the sealing surface 22 of the spring member 1E serving as a liquid supply valve so as to push the cap body 14 serving as a valve lid to the upstream of the insert receiving member 91 serving as a channel against the elastic member 13. When the cap body 14 is pushed up, the upper surface 93a of the packing 93 and the sealing surface 22 are separated so that the liquid discharged from the ejection port 74a of the pressure control mechanism 74 flows to the downstream portion of the insert receiving member 91 serving as a channel.

At the same time, the downstream portion of the channel and communicates with the liquid channel 102 in the liquid supply needle 100 through the introduction port 101a in a liquid-tight manner so that the liquid is supplied to the ink head through the liquid channel 102 without leaking from the liquid supply port 90.

In the spring member 1E, the cap body 14 that serves as a valve lid for the liquid supply valve and the elastic member 13 that urges the cap body 14 are integrally formed. By applying such a spring member 1E to the liquid supply valve in the liquid supply port 90 of the liquid cartridge 70, the spring member 1E including the elastic member 13 in a multi-tiered columnar shape having an octagonal section contracts in the perpendicular direction without bending in the insert receiving member 91, in addition to the advantages gained from the above-described spring member 1A.

Therefore, the cap body 14 does not incline in the insert receiving member 91 when the cap body 14 is pushed up by the liquid supply needle 100, maintaining a horizontal posture when separated from the upper surface 93a of the packing 93. When the liquid supply valve 100 is removed, the sealing surface 22 contacts the upper surface 93a while maintaining the horizontal posture so that insufficient sealing due to inappropriate loading of the liquid cartridge 70 is prevented.

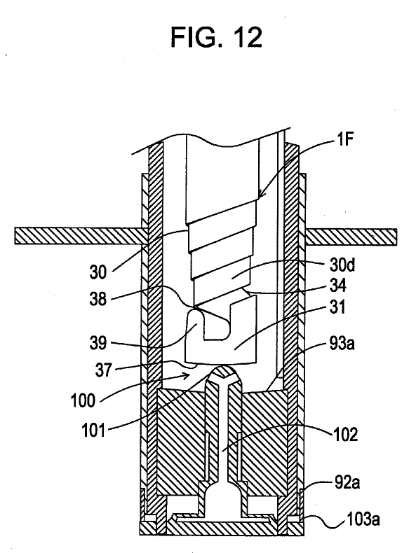

FIG. 12 shows a state when the above-described spring member 1F as a liquid supply valve is fitted into the liquid cartridge 70, and the liquid cartridge 70 is mounted on the engagement mechanism 103a in the holder mechanism 61A.

In this state, the tip portion 101 of the liquid supply needle 100 contacts the sealing surface 37 of the spring member 1E serving as a liquid supply valve so as to push the cap body 31 serving as a valve lid to the upstream of the insert receiving member 91 serving as a channel against the elastic member 30. The protruding piece 39 contacts a vicinity of the edge portion 38 of the lower tier 30d immediately above.

When the cap body 31 is pushed up, the upper surface 93a of the packing 93 and the sealing surface 37 are separated so that the liquid discharged from the ejection port 74a of the pressure control mechanism 74 flows to the downstream portion of the insert receiving member 91 serving as a channel.

At the same time, the downstream portion of the channel communicates with the liquid channel 102 in the liquid supply needle 100 through the introduction port 101a in a liquid-tight manner so that the liquid is supplied to the ink head through the liquid channel 102 without leaking from the liquid supply port 90.

In the spring member 1F the cap body 31 that serves as a valve lid for the liquid supply valve and the elastic member 30 that urges the cap body 31 are integrally formed. By applying such a spring member 1F to the liquid supply valve in the liquid supply port 90 of the liquid cartridge 70, since the spring member 1F contracts in a state that the protruding piece 39 contacts the edge portion 38 of the lower tier 30d immediately above, the neck portion 34 opposite the protruding piece 39 does not bend, in addition to the advantages gained from the above-described spring member 1A.

Therefore, the cap body 31 does not incline in the insert receiving member 91 when the cap body 31 is pushed up by the liquid supply needle 100, maintaining a horizontal posture when separated from the upper surface 93a of the packing 93. When the liquid supply valve 100 is removed, the sealing surface 22 contacts the upper surface 93a while maintaining the horizontal posture so that insufficient sealing due to inappropriate loading of the liquid cartridge 70 can be prevented. Although drawings are omitted, any of the spring members 1B, 1C, and 1D applied to a liquid supply valve brings the same action and advantage as in the case where the spring member 1A is applied to a liquid supply valve.

The present invention is described on the basis of the embodiments. However, the technical scope of the present invention is not limited to the above-described embodiments. In addition to the spring members according to the present invention, spring members may be made of a material such as a stainless steel plate laminated with a nickel layer or of a copper alloy.

1. A spring member comprising an elastic member with elasticity in a certain direction, and a particular member disposed at one or both ends of the elastic member, wherein the elastic member and the particular member are integrated.

2. The spring member according to claim 1, wherein the particular member is a cap body having an opening toward the elastic member and a sealing surface on an end of the cap body, and wherein an edge portion of the opening is integrated with the elastic member.

3. The spring member according to claim 2, wherein the cap body includes a protruding piece protruding from the edge portion of the opening toward the elastic member, and wherein the protruding piece contacts the elastic member and prevents the cap body from inclining when the elastic member contracts.

4. The spring member according to claim 1, wherein the elastic member is a spiral body of a wound narrow metal strip and an end of the spiral body and the edge portion of the cap body are integrated.

5. The spring member according to claim 1, wherein the elastic member is a narrow metal strip bent a plurality of times in a longitudinal direction and an end of the metal strip and the edge portion of the cap body are integrated.

6. The spring member according to claim 2, wherein the cap body is made from a metal plate integrated with the elastic member by a pressing process or a drawing process.

7. A liquid cartridge mounted to a liquid supply needle disposed on a recording apparatus, the liquid cartridge comprising a liquid container and a liquid supply port into which the liquid supply needle is inserted, the liquid supply port including the spring member according to claim 1, wherein the elastic member urges the cap body to the opening of the liquid supply port and the cap body closes the liquid supply port.

8. A recording apparatus comprising the liquid cartridge according to claim 7.
